(19) United States
(12) Patent Application Publication
(10) Pub. No.: US 2022/0270027 A1
(43) Pub. Date: Aug. 25, 2022

(54) CROWDSOURCING LOCATION DATA FOR A PLANOGRAM

(71) Applicant: Maplebear, Inc. (DBA Instacart), San Francisco, CA (US)

(72) Inventors: Conor Edward Woods, Oakland, CA (US); Kevin Michael Henrikson, Hillsborough, CA (US); Teodor Lefter, Leander, TX (US)

(21) Appl. No.: 17/180,395

(22) Filed: Feb. 19, 2021

(51) Int. Cl. G06Q 10/08; H04W 4/024; G06F 16/44

(52) U.S. Cl. CPC G06Q 10/087; H04W 4/024; G06F 16/444

(57) ABSTRACT

An online system receives, scans from a plurality of picker client devices. Each scan comprises an item identifier and a location in a store where the item was scanned. The online system creates a map of the store based on location data received from a picker client device as a picker moves around the store. Using the map and the scans, the online system builds a planogram of the store. The planogram comprises a mapping of a plurality of locations in the store to one or more items at each of the plurality of locations. The online system receives an order of items to be fulfilled at the store from a customer client device and determines location information describing locations of the items in the store based on the planogram. The online system transmits, to a picker mobile device, the location information for display.

### BACKGROUND

This disclosure relates generally using planograms. More particularly, the disclosure relates to using a planogram of a store determined based on crowdsourced location data to guide pickers through the retail location.

Order delivery systems allow customers to place orders for delivery or pick up. The orders are fulfilled by pickers at stores using a mobile application to aide in finding items for the orders. However, the pickers may not be able to find the most efficient routes through a store when picking items for orders. Though the mobile application may attempt to guide the pickers on efficient routes, the mobile application may not have the most updated information about item organization within the store, especially since items may be located in multiple spots throughout the store and may be frequently moved during reorganization. Thus, a system for creating and using an up-to-date planogram of stores is necessary.

### SUMMARY

To create a planogram of a store, an online concierge system receives scans from one or more client devices describing locations of items in a store. The online concierge system uses the scans to build a planogram of the store. The online concierge system receives an order of items from a customer client device and determines, based on the planogram, location information about the items in the order, which the online concierge system transmits to a picker client device for display.

More particularly, in some embodiments, the online concierge system receives scans from a plurality of picker client devices. Each scan comprises an item identifier and a location in a store where the item was scanned. The online concierge system builds a planogram of the store based on the scans. The planogram comprises mappings of a plurality of locations in the store to one or more items at each of the plurality of locations. The online concierge system receives an order of one or more items to be fulfilled at the store from a customer client device and determines, based on the planogram, location information describing locations of the items in the store. The online concierge system transmits the location information for display to a picker mobile device of a picker assigned to fulfill the order. The location data may include a map of the store, locations of the items in the order, a sequence of items in the order, and/or a suggested route through the store.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 illustrates the environment of an online concierge system, according to one embodiment.

FIG. 2 is a block diagram of an online concierge system, according to one embodiment.

FIG. 3A is a block diagram of the customer mobile application (CMA), according to one embodiment.

FIG. 3B is a block diagram of the picker mobile application (PMA), according to one embodiment.

FIG. 4 is a block diagram of a planogram engine, according to one embodiment.

FIG. 5A is a picker order interface showing items in an order, according to one embodiment.

FIG. 5B is a picker order interface showing a map of a store, according to one embodiment.

FIG. 5C is a picker order interface showing a route through a map of a store, according to one embodiment.

FIG. 6 is a flowchart illustrating a process for transmitting location information, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### Environment of an Online Concierge System

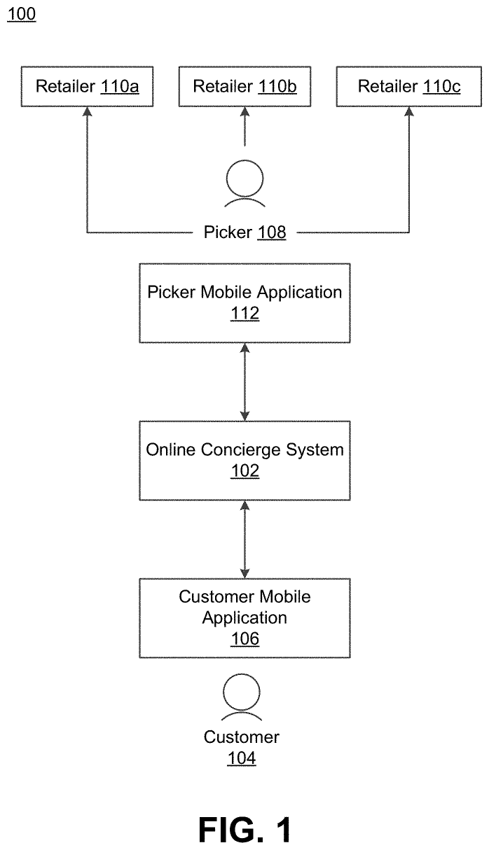

FIG. 1 illustrates the environment 100 of an online concierge system 102, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The online concierge system 102 is configured to receive orders from one or more customers 104 (only one is shown for the sake of simplicity). An order specifies a list of goods (items or products) to be delivered to the customer 104. The order also specifies the location to which the goods are to be delivered, and a time window during which the goods should be delivered. In some embodiments, the order specifies one or more retailers from which the selected items should be purchased. The customer 104 may use a customer mobile application (CMA) 106 to place the order; the CMA 106 is configured to communicate with the online concierge system 102.

The online concierge system 102 is configured to transmit orders received from customers 104 to one or more pickers 108. A picker 108 may be a contractor, employee, or other person (or entity) who is enabled to fulfill orders received by the online concierge system 102. The environment 100 also includes three retailers 110a, 110b, and 110c (only three are shown for the sake of simplicity; the environment could include hundreds of retailers). The retailers 110 may be physical retailers, such as grocery stores, discount stores, department stores, etc., or non-public warehouses storing items that can be collected and delivered to customers 104. The retailers may also be referred to as warehouse locations. Each picker 108 fulfills an order received from the online concierge system 102 at one or more retailers 110, delivers the order to the customer 104, or performs both fulfillment and delivery. In one embodiment, pickers 108 make use of a picker mobile application 112 which is configured to interact with the online concierge system 102.

### Online Concierge System

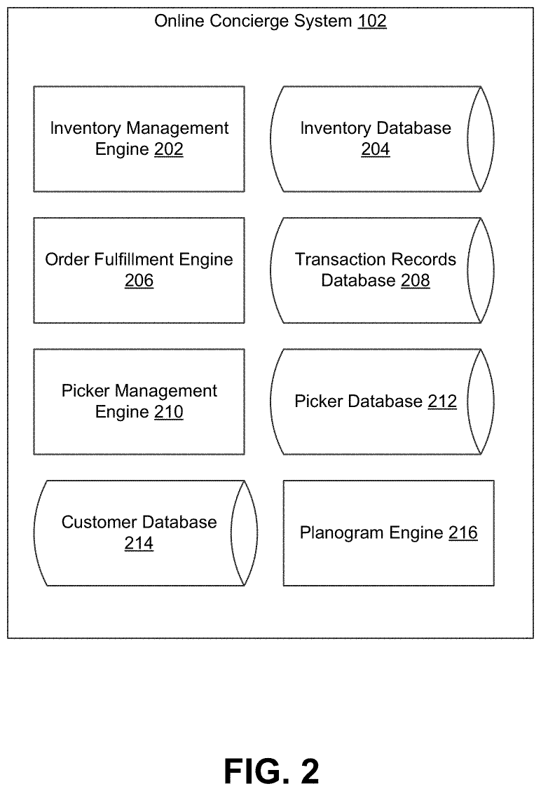

FIG. 2 is a block diagram of an online concierge system 102, according to one embodiment. The online concierge system 102 includes an inventory management engine 202, which interacts with inventory systems associated with each retailer 110. In one embodiment, the inventory management engine 202 requests and receives inventory information maintained by the retailer 110. The inventory of each retailer 110 is unique and may change over time. The inventory management engine 202 monitors changes in inventory for each participating retailer 110. The inventory management engine 202 is also configured to store inventory records in an inventory database 204. The inventory database 204 may store information in separate records—one for each participating retailer 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204.

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which retailers 110. The order fulfillment engine 206 determines a sale price for each item ordered by a customer 104. Prices set by the order fulfillment engine 206 may or may not be identical to in-store prices determined by retailers 110 (which is the price that customers 104 and pickers 108 would pay at retailers). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

The order fulfillment engine 206 also determines replacement options for items in an order. For each item in an order, the order fulfillment engine 206 may retrieve data describing items in previous orders facilitated by the online concierge system 102, previously selected replacement options for that item, and similar items. Similar items may be items of the same brand or type or of a different flavor. Based on this data, the order fulfillment engine 206 creates a set of replacement options for each item in the order comprising the items from the data. The order fulfillment engine 206 ranks replacement options in the set to determine which items to display to the customer 104. In some embodiments, the order fulfillment engine 206 may rank the replacement options by the number of previous orders containing the replacement option or user quality ratings gathered by the online concierge system 102. In some embodiments, the order fulfillment engine 206 only uses data for the customer 104 related to the order to suggest replacement options.

In some embodiments, the order fulfillment engine 206 also shares order details with retailer 110. For example, after successful fulfillment of an order, the order fulfillment engine 206 may transmit a summary of the order to the appropriate retailer 110. The summary may indicate the items purchased, the total value of the items, and in some cases, an identity of the picker 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a picker management engine 210, which manages communication with and utilization of pickers 108. In one embodiment, the picker management engine 210 receives a new order from the order fulfillment engine 206. The picker management engine 210 identifies the appropriate retailer 110 to fulfill the order based on one or more parameters, such as the contents of the order, the inventory of the retailers 110, and the proximity to the delivery location. The picker management engine 210 then identifies one or more appropriate pickers 108 to fulfill the order based on one or more parameters, such as the picker's proximity to the appropriate retailer 110 (and/or to the customer 104), his/her familiarity level with that particular retailer 110, and so on. Additionally, the picker management engine 210 accesses a picker database 212 which stores information describing each picker 108, such as his/her name, gender, rating, previous shopping history, and so on. The picker management engine 210 transmits the list of items in the order to the picker 108 via the picker mobile application 112. The picker database 212 may also store data describing the sequence in which the pickers 108 picked the items in their assigned orders.

As part of fulfilling an order, the order fulfillment engine 206 and/or picker management engine 210 may access a customer database 214 which stores information describing each customer 104. This information could include each customer's name, address, gender, shopping preferences, favorite items, stored payment instruments, and so on.

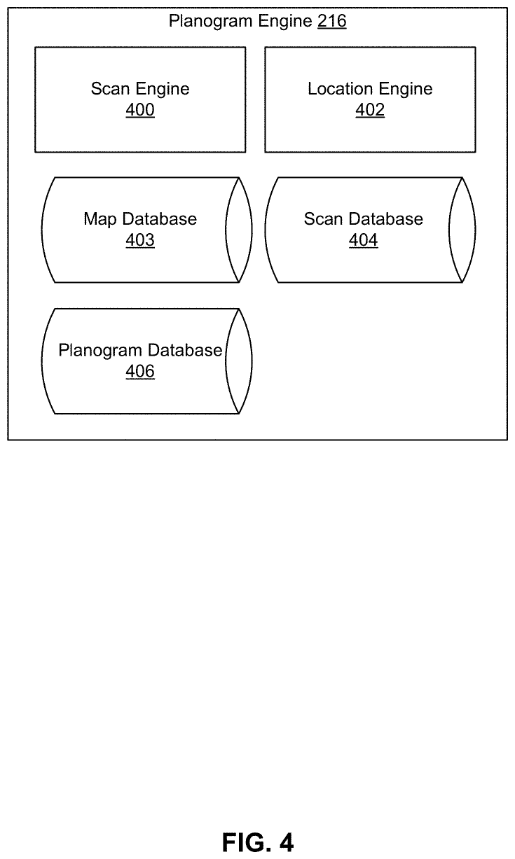

The planogram engine 216 builds planograms of physical locations of retailers 110 (henceforth referred to as stores) using scans received from the PMA 112. The planogram engine 216 further uses planograms of stores to determine location information about each store that may be used to aid pickers 108 fulfilling orders at the store. The planogram engine 216 is further described in relation to FIG. 4.

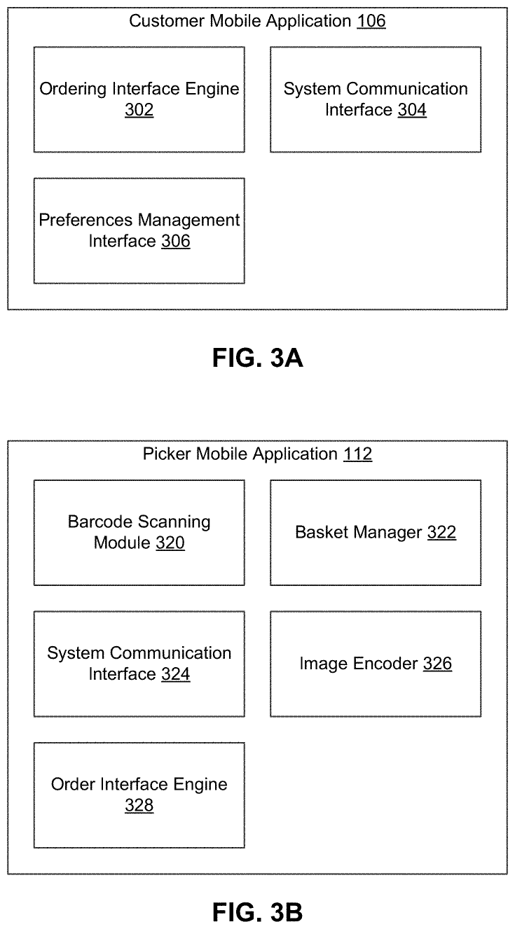

FIG. 3A is a block diagram of the customer mobile application (CMA) 106, according to one embodiment. The customer 104 accesses the CMA 106 via a client device, such as a mobile phone, tablet, laptop, or desktop computer. The CMA 106 may be accessed through an app running on the client device or through a website accessed in a browser. The CMA 106 includes an ordering interface 302, which provides an interactive interface, known as a customer ordering interface, with which the customer 104 can browse through and select products and place an order.

Customers 104 may also use the customer ordering interface to message with pickers 108 and receive notifications regarding the status of their orders. Customers 104 may view their orders and communicate with pickers 108 regarding an issue with an item in an order using the customer ordering interface. For example, a customer 104 may respond to a message from a picker 108 indicating that an item cannot be retrieved for the order by selecting a replacement option for the item or requesting a refund via buttons on the customer ordering interface. Based on the chosen course of action, the customer ordering interface generates and displays a template message for the customer 104 to send to the picker 108. The customer 104 may edit the template message to include more information about the item or course of action and communicate back and forth with the picker 108 until the issue is resolved.

The CMA 106 also includes a system communication interface 304 which, among other functions, receives inventory information from the online concierge system 102 and transmits order information to the online concierge system 102. The CMA 106 also includes a preferences management interface 306 which allows the customer 104 to manage basic information associated with his/her account, such as his/her home address and payment instruments. The preferences management interface 306 may also allow the user to manage other details such as his/her favorite or preferred retailers 110, preferred delivery times, special instructions for delivery, and so on.

FIG. 3B is a block diagram of the picker mobile application (PMA) 112, according to one embodiment. The picker 108 accesses the PMA 112 via a mobile client device, such as a mobile phone or tablet. The PMA 112 may be accessed through an app running on the mobile client device or through a website accessed in a browser. The PMA 112 includes a barcode scanning module 320 which allows a picker 108 to scan an item at a retailer 110 (such as a can of soup on the shelf at a grocery store). The barcode scanning module 320 may also include an interface which allows the picker 108 to manually enter information describing an item (such as its serial number, SKU, quantity and/or weight) if a barcode is not available to be scanned. The PMA 112 also includes a basket manager 322 which maintains a running record of items collected by the picker 108 for purchase at a retailer 110. This running record of items is commonly known as a “basket.” In one embodiment, the barcode scanning module 320 transmits information describing each item (such as its cost, quantity, weight, etc.) to the basket manager 322, which updates its basket accordingly. The PMA 112 also includes an image encoder 326 which encodes the contents of a basket into an image. For example, the image encoder 326 may encode a basket of goods (with an identification of each item) into a QR code which can then be scanned by an employee of the retailer 110 at check-out.

The PMA 112 also includes a system communication interface 324, which interacts with the online concierge system 102. For example, the system communication interface 324 receives information from the online concierge system 102 about the items of an order, such as when a customer 104 updates an order to include more or fewer items. The system communication interface 324 may receive notifications and messages from the online concierge system 102 indicating information about an order or communications from a customer 104. The system communication interface 324 may additionally generate a picker order interface to be transmitted via the PMA 112 to a picker to show orders submitted by customers 104, location information about each order, and messages from customers 104. The system communication interface 324 may receive orders and messages from customer 104 via the CMA 106 and location information from the planogram engine 216.

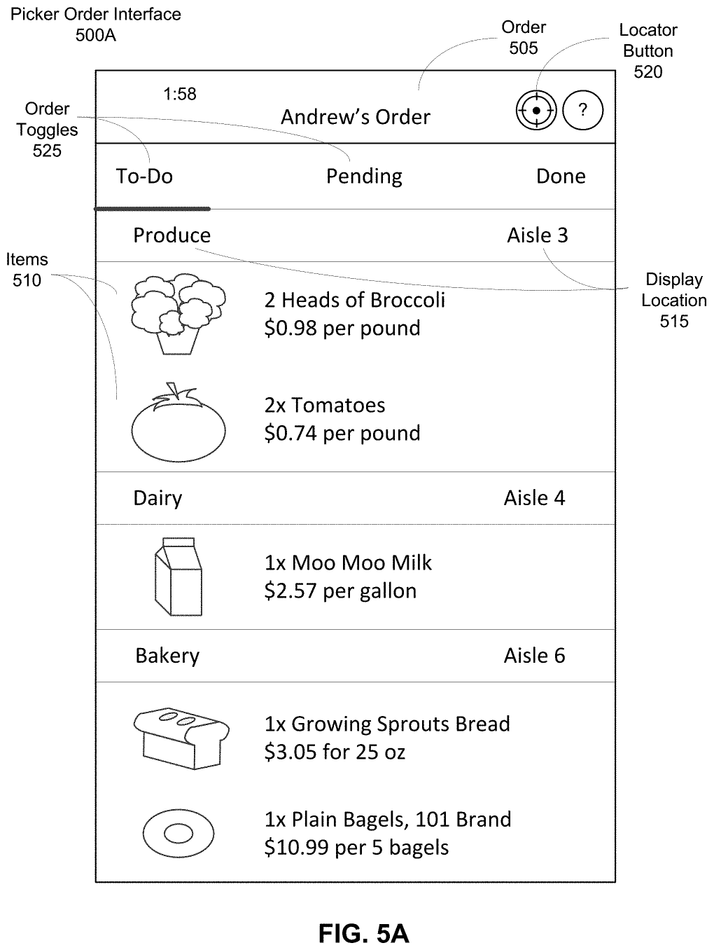

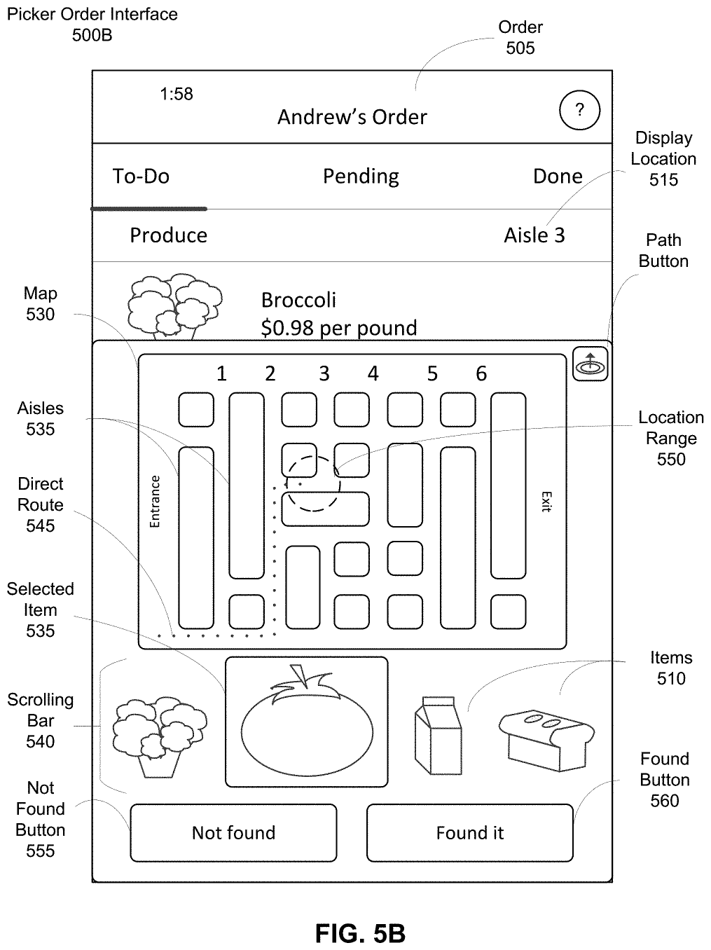

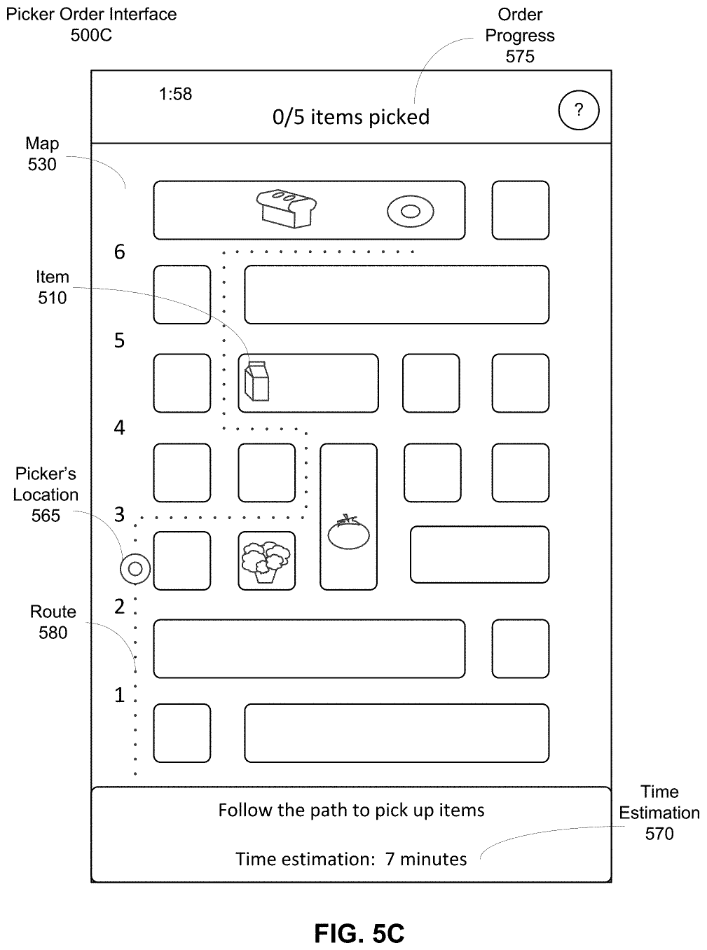

A picker order interface is an interactive interface through which pickers 108 may interact with customers 104 and receive notifications regarding the status of orders they are assigned. Pickers 108 may view their orders through the picker order interface and indicate when there is an issue with an item in an order, such as not being able to find the item, and when they have picked an item for an order (e.g., via an interactive element or scanning the item). The picker order interface displays location information about orders, such as a map of a store associated with the order, locations of items in the order (e.g., aisle, section, department, etc. of the store), a sequence for picking the items, a route through the store, a picker's location in the store, and the like. The picker order interface is further described with respect to FIGS. 5A-5C.

In some embodiments, the PMA 112 also includes a preferences management interface 306 which allows the picker 108 to manage basic information associated with his/her account, such as his/her name, preferred shopping zone, status, and other personal information. The preferences management interface 306 may also allow the picker 108 to review previous orders and/or his/her shopping level.

FIG. 4 is a block diagram of the planogram engine 216, according to one embodiment. The planogram engine 216 includes a scan engine 400, a location engine 402, a map database 403, a scan database 404, and a planogram database 406. In some embodiments, the planogram engine 216 has more or different components than those shown in FIG. 4, or the components shown in FIG. 4 may be combined or removed. In other embodiments, the methods and processes described in relation to the planogram engine 216 may be performed at other engines or systems.

The scan engine 400 builds maps of stores based on location data received from the PMA 112. A map may be a two-dimensional representation of the store (e.g., the layout of aisles). To create a map of a store, the scan engine 400 may use location data sent from the PMA 112 as a picker 108 (and the picker's client device, i.e., a picker client device) moves around the store. The scan engine 400 creates the map based on where the picker 108 moved within the store and where the picker 108 did not move within the store. For example, if the picker 108 never goes to a specific area the store, such as a rectangular section in the center of the store, the scan engine 400 may determine that the area is not traversable by the picker 108 and block that area off in the map.

In some embodiments, the scan engine 400 may also receive image data from the PMA 112 as the picker 108 moves around the store. The scan engine 400 may use the image data to augment the scan engine's understanding of the map of the store by building a three-dimensional representation of the store. For instance, if a section of the store that the picker 108 has not moved through has shelves in the image data, the scan engine 400 may create a representation of the shelves in the map. In other embodiments, the scan engine 400 may retrieve a map of the store from the retailer 100, which the scan engine 400 may update based on the image and location data. The scan engine stores maps in the map database 403.

The scan engine 400 receives scans of items from the barcode scanning module 320 of the PMA 112. The scan may be transmitted from one or more picker client devices executing the PMA 112 as pickers 108 retrieve and scan items for orders. Each scan comprises an item identifier, which may be used to identify the item scanned, and a location in a store where the associated picker client device was when the item was scanned. The scan may also include the name of the retailer 110 of the store, a price of the item, and any other suitable item information. In some embodiments, a scan may include GPS data instead of the location, and the scan engine 400 may use to determine the location of the item scanned based on the GPS data. In other embodiments, the scan may include image data along with the location data, and the scan engine 400 may use the image data to determine a precise location of the item (e.g., a specific shelf within the store) based on image recognition. The scan engine stores the scans in the scan database 404.

The scan engine 400 builds a planogram of each store based on the scans. A planogram is a visual representation of where items are located in a store. To build a planogram, the scan engine 400 retrieves a map of a store from the map database 403. The scan engine 400 retrieves scans from the store from the scan database 404 and, for each scan, determines an item that was scanned based on the item identifier. The scan engine 400 adds the item to the map at the location of the scan, which may be an aisle, a specific shelf, or the like.

In some embodiments, the scan engine 400 may add the same item to multiple locations in the planogram such that the planogram represents a heat map of items at various locations in the store. For example, for the item “Texas Toast Croutons,” the planogram may include the item 20 times in the middle of Aisle 5 next to items such as “Cool Ranch Dressing” and “Garlic Croutons” and 3 times in a vegetable section of the store next to the item “Spring Salad Mix.” In other embodiments, the planogram may be segmented into a multitude of heat maps each describing locations of an item in the store. The heat map may represent a magnitude of the item at locations in the store (e.g., an area of the store with a high magnitude has more locations of the item associated with the area than an area with a low magnitude). In some embodiments, the heat map may be segmented into areas of the store and each area may be associated with a probability that the item would be found in the area. The probability may be determined based on instances when the item was previously found in the area. The scan engine 400 stores the planograms in the planogram database 406 and updates the planograms based on new scans received from the PMA 112 over time.

The location engine 402 determines location information for orders based on the planograms. Location information may include a display location of each item in an order, a sequence for picking items in the order, a route through a store associated with the order, and the like. In particular, the location engine 402 receives orders of items from the system communication interface 304 of the CMA 104. For each order, the location engine 402 receives a picker 108 assigned the order from the picker management engine 210. In some embodiments, the location engine 402 may retrieve other orders assigned to the picker 108 from the picker database 212.

The location engine 402 accesses a planogram of a store for the order. For each item in the order (or orders, in some embodiments), the location engine 402 receives locations of the item in the planogram and determines a display location of the item. The display location is representative of the locations of the item in the planogram. In some embodiments, the display location may be a midpoint of the locations of the item in the planogram. In other embodiments, the display location may be determined based on a highest magnitude in the planogram (i.e., heat map, in these embodiments). In further embodiments, the location engine 402 may determine a location range for each item based on the planogram. The location range may be an area within the planogram containing a threshold percentage of the locations of the item (e.g., 90% of the locations) or may be a particular area of the store (e.g., aisle, section, department, etc.). Alternatively, the location range may be a circular area centered around a location within the planogram with the highest concentration of locations and with a radius of a set amount (e.g., 5 feet). The location engine 402 may use the location range as the display location or may select a center of the location range as the display location.

The location engine 402 may determine a sequence of the items to recommend the picker 108 pick the items in. For instance, the location engine 402 may apply a machine-learned picking sequence model to the items, display locations, and store (or retailer 110) of the order to determine an optimal sequence to pick the items in. The machine-learned picking sequence model is described in co-pending U.S. application Ser. No. 15/882,934, filed on Jan. 29, 2018. The sequence may be ordered by department, aisle, or any other organization information about the store. In some embodiments, the location engine 402 may determine a sequence for all items the picker 108 needs to pick (i.e., for all orders assigned to the picker 108) to improve the efficiency of picking. For example, a picker 108 may be assigned a first order and a second order. The first order may include the items “Organic Raspberries” and “Fluffy's Light Whipping Cream,” and the second order may include the items “Spring Salad Mix” and “Organic Raspberries.” To improve the picker's efficiency retrieving the items, the optimal picking sequence for the picker 108 may be in the order of one package of “Spring Salad Mix,” two pints of “Organic Raspberries,” and one package of “Fluffy's Light Whipping Cream.” This sequence allows the picker 108 to pick for both orders at once rather than making multiple trips through the same areas of the store.

The location engine 402 may determine a route through the store for the items in the order (or all items in orders assigned to the picker 108). The location engine 402 may map the determined sequence to the planogram of the store and create a route through the store that passes each item in the sequence. The route may be associated with specific directions that may be sent to the picker 108 (e.g., “turn left into Aisle 2” and the like). In some embodiments, the location engine 402 may update the sequence based on previous shopping history describing how the picker 108 has historically picked items. For instance, the location engine 402 may retrieve the picker's previous shopping history from the picker database 212 and determine, based on the previous shopping history, that the picker 108 generally starts shopping in a produce section of the store and finishes shopping in a frozen foods section. The location engine 402 may adjust the route based on this data to reflect the picker's 108 habits while shopping (e.g., adjusting the route to start in the produce section and end in the frozen foods section).

The location engine 402 sends the location information (e.g., display locations, location ranges, sequence, and route) to the PMA 112 for display to the picker 108 via the picker order interface, as described in relation to FIG. 3B. The picker order interface is also described in relation to FIGS. 5A-5C. The location engine 402 may update the location information upon receiving indications from the basket manager 322 of the PMA 112 about items the picker 108 has picked at the store. For instance, the location engine 402 may update the sequence or route upon determining that the picker 108 has picked one or more items from the order (or orders). The location engine 402 sends the updated location information to the PMA 112 for display to the picker 108 via the picker order interface.

FIG. 5A is a picker order interface 500A showing items 510 in an order 505, according to one embodiment. The order 505 may include a name of a customer 104 (or other customer information), items 510 in the order, and a display location 515. In the picker order interface 500A of FIG. 5A, the items 510 are organized by corresponding display location 515 (e.g., section of store and aisle). For example, the item “Moo Moo Milk” is located in the “Dairy” section of the store in Aisle 4. In some embodiments, the arrangement of the items in the picker item interface 500A may reflect the sequence to pick the items in. The picker order interface 500A also includes one or more order toggles, which the picker 108 may interact with to show items that still need to be picked (e.g., “To Do”), items that have been picked (e.g., “Pending”), and items that the customer 104 previously purchased (E.g., “Done). The picker order interface 500a may include additional interactive elements, such as the locator button 520, which the picker 108 may interact with to a display a map of the store.

FIG. 5B is a picker order interface 500B showing a map 530 of a store, according to one embodiment. In some embodiments, the picker order interface 500B may be shown in response to receiving an interaction with the locator button 520 of FIG. 5A. The map 530 shows a layout of aisles 535 in the store and is coupled with a scrolling bar 540 of items 510 in the order 505. The items 510 in the scrolling bar 540 may be ordered to reflect the sequence for picking the items 510. The picker 108 may select an item 510 in the scrolling bar to display a direct route 545 to the display location 515 or location range 550 of the item 510 in the map 530. Alternatively, the picker 108 may interact with the path button 565 to display a route through the store for picking all of the items 510 in the order 505.

While picking, if the picker 108 cannot find the selected item 535, the picker may interact with the not found button 555 to indicate that the selected item 535 is out of stock, missing from the display location 515/location range 550, or otherwise unavailable. Alternatively, if the picker 108 has found the selected item 535 while picking, the picker 108 may interact with the found button 560 to indicate that the selected item 535 has been picked. The picker order interface 500B may subsequently update to show an updated sequence or route to one or more items.

FIG. 5C is a picker order interface 500C showing a route 580 through a map 530 of a store, according to one embodiment. In this embodiment, the picker order interface 500C display the entire route 580 for picking all of the items 510 in the order 505 whereas in some embodiments, the picker order interface 500C may only display a subset of the route 580, such as the direct route 545 of FIG. 5B. The route 580 extends through the map 530 of the store to pass each item 510 in the order 505, such that if the picker 108 followed the route 580, he/she would be able to pick all of the items 510 of the order.

The picker order interface 500C may also show the picker's location 565 on the map in real-time based on location data received via the PMA 112. As the picker 108 picks items, the picker order interface 500C updates a time estimation 570 and order progress 575 based on the picker's location 565. The time estimation 570 indicates an amount of time that a picker 108 following the route from the picker's location 565 would likely take and may be determined based on previous shopping history describing a picker's speed while picking items 510. The order progress 575 describes how many items 510 are left to be picked from the order 505 and may be determined based on interactions with the found button 560 of the user interface 500B and/or scanning information received from the PMA 112 as the picker 108 scans items 510.

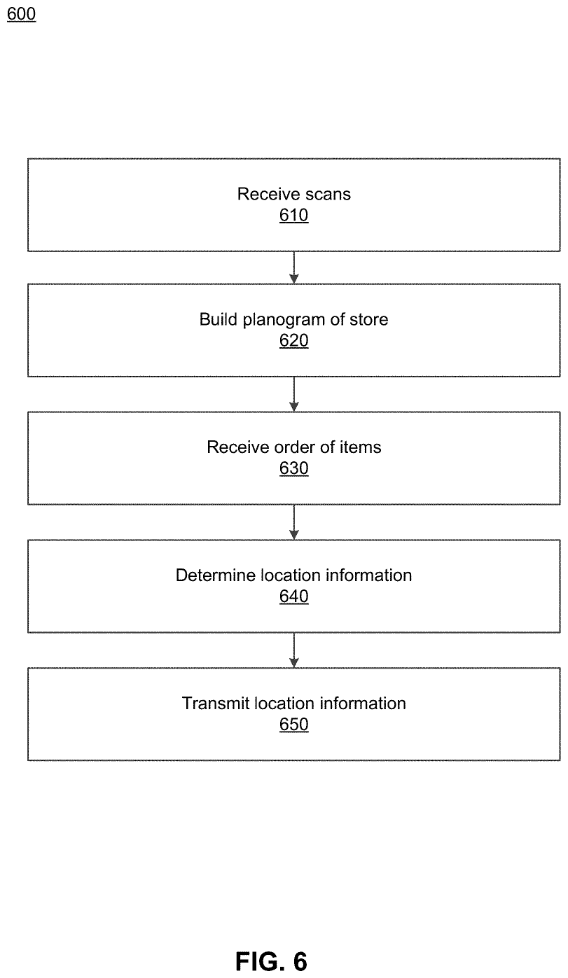

FIG. 6 is a flowchart illustrating a process 600 for transmitting 650 location information, according to one embodiment. The scan engine 400 receives 610, from a plurality of picker client devices executing the PMA 112, scans from a store. Each scan comprises an item identifier and a location in the store where an item associated with the item identifier was scanned. The scan engine 400 determines a map of the store. For example, the scan engine 400 may analyze location information describing movement of the plurality of picker client devices around the store to create a map of the store or may receive a map of the store from a retailer 110. The scan engine 400 builds 620 a planogram of the store based on the scans and the map. The planogram comprises a mapping of a plurality of locations in the store to one or more items in each of the plurality of locations. The scan engine 400 determines locations of items based on the scans and adds the items to the map at the locations. The scan engine 400 stores the planogram with the mappings to the planogram database 406 and may update the planogram to include more mappings as the scan engine 400 receives scans from picker client devices via the PMA 112.

The location engine 402 receives 630 an order of items to be fulfilled at the store from a customer client device executing the CMA 106. The location engine 402 determines 640 location information describing locations of the items in the store based on the planogram. The location information may include the locations of the items, the map of the store, a route through the store to each of the items, and a sequence to pick the items in. The location engine 502 may determine the sequence using a machine-learned picking sequence model. The location engine 402 transmits 650 the location information to the PMA 112 for display in a picker order interface 500 to a picker 108 assigned to fulfill the order. For example, the location information may be displayed in a table of the items with corresponding row/aisle numbers (i.e., display locations), a next item to be picked in a sequence of the items, a set of directions describing a route to take through the store to pick items in the sequence, and the like.

The location engine 402 may send new location information to the picker client device upon receiving scans from the picker client device. In particular, as the picker 108 moves about the store scanning items for the order, the location engine 402 may update the sequence of items to be picked to not include the scanned items and/or start the sequence from his/her current location of the picker 108 in the store. Further, the location engine 402 may remove the scanned items from the table or map. The location engine 402 may transmit the updated location information for display to the PMA 112 and continue updating the location information until the picker 108 has retrieved all of the items in the order.

It is appreciated that although FIG. 6 illustrates a number of interactions according to one embodiment, the precise interactions and/or order of interactions may vary in different embodiments. For example, in some embodiments, the location data may reflect location ranges of each item in the store. A location range may be represented as an area of the map in the store where the item has been found, based on multiple locations from the scans received from picker client devices. For example, the location range may show a portion of an aisle in the store if the item is spread throughout the aisle.

In some embodiments, the scan engine 400 may update the planogram responsive to receiving new scans for an item identifier. If an item associated with an item identifier in a new scan is already shown in the planogram, the scan engine 400 may update the planogram to add the item to the location from the new scan, such that the planogram reflects multiple locations for the item. In some instances, if a threshold amount of time has passed since the item was last shown in a scan at an old location, the scan engine 400 may remove the item from the planogram at the old location so that the planogram reflects a current state of locations of items in the store.

In some embodiments, the location engine 402 uses the planogram, rather than the machine-learned picking sequence model, to determine routes through the store for picking the items. For example, the location engine 402 may determine a plurality of routes the picker 108 could take through the store to retrieve the items in one or more orders assigned to the picker 108. A route may follow a suggested sequence of items that may be efficient for picking (i.e., picking all items in a fruit section before moving to a dairy section). Each of the plurality of routes may start from different locations in the store or vary by sequence. The location engine 402 may estimate a time for completing each route and select a route with the lowest estimated time as the most efficient route. The location engine 402 may transmit the most efficient route to the picker client device 108 and update the route as the picker moves through the store.

### Other Considerations

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method comprising:
receiving scans from a plurality of picker client devices, each scan comprising an item identifier and a location in a store where the item was scanned;
building a planogram of the store based on the scans, where the planogram comprises a mapping of a plurality of locations in the store to one or more items at each of the plurality of locations;
receiving, from a customer client device, an order of items to be fulfilled at the store;
determining, based on the planogram, location information describing locations of the items in the store; and
transmitting, to a picker mobile device, the location information for display.

2. The computer-implemented method of claim 1, wherein the location in the store of each scan is determined based on GPS data.

3. The computer-implemented method of claim 2, wherein the GPS data is captured from a picker mobile device as an item associated with the item identifier is scanned.

4. The computer-implemented method of claim 1, wherein the location data comprises one or more of a map of the store, a location of each item in the order, and a route through the store to each item in the order.

5. The computer-implemented method of claim 1, wherein the planogram reflects location ranges of one or more items available at the store.

6. The computer-implemented method of claim 1, further comprising:
responsive to receiving new scans for an item identifier at a new location in the store, updating the planogram to include an item associated with the item identifier at the location, wherein the updated planogram includes the item at two or more locations in the store.

7. The computer-implemented method of claim 1, wherein the planogram includes an item of the items in the order at two or more locations in the store, the method further comprising:
determining, based on the planogram, two or more routes through the store for picking the items in the order based on the planogram; and
transmitting a most efficient route of the two or more routes to the picker client device for display.

8. A non-transitory computer-readable storage medium comprising instructions executable by a processor, the instructions comprising:
instructions for receiving scans from a plurality of picker client devices, each scan comprising an item identifier and a location in a store where the item was scanned;
instructions for building a planogram of the store based on the scans, where the planogram comprises a mapping of a plurality of locations in the store to one or more items at each of the plurality of locations;
instructions for receiving, from a customer client device, an order of items to be fulfilled at the store;
instructions for determining, based on the planogram, location information describing locations of the items in the store; and
instructions for transmitting, to a picker mobile device, the location information for display.

9. The non-transitory computer-readable storage medium of claim 8, wherein the location in the store of each scan is determined based on GPS data.

10. The non-transitory computer-readable storage medium of claim 9, wherein the GPS data is captured from a picker mobile device as an item associated with the item identifier is scanned.

11. The non-transitory computer-readable storage medium of claim 8, wherein the location data comprises one or more of a map of the store, a location of each item in the order, and a route through the store to each item in the order.

12. The non-transitory computer-readable storage medium of claim 8, wherein the planogram reflects location ranges of one or more items available at the store.

13. The non-transitory computer-readable storage medium of claim 8, the instructions further comprising:
responsive to receiving new scans for an item identifier at a new location in the store, instructions for updating the planogram to include an item associated with the item identifier at the location, wherein the updated planogram includes the item at two or more locations in the store.

14. The non-transitory computer-readable storage medium of claim 8, wherein the planogram includes an item of the items in the order at two or more locations in the store, the instructions further comprising:
instructions for determining, based on the planogram, two or more routes through the store for picking the items in the order based on the planogram; and
instructions for transmitting a most efficient route of the two or more routes to the picker client device for display.

15. A computer system comprising:
a computer processor; and
a non-transitory computer-readable storage medium storing instructions that when executed by the computer processor perform actions comprising:
receiving scans from a plurality of picker client devices, each scan comprising an item identifier and a location in a store where the item was scanned;
building a planogram of the store based on the scans, where the planogram comprises a mapping of a plurality of locations in the store to one or more items at each of the plurality of locations;
receiving, from a customer client device, an order of items to be fulfilled at the store;
determining, based on the planogram, location information describing locations of the items in the store; and
transmitting, to a picker mobile device, the location information for display.

16. The computer system of claim 15, wherein the location in the store of each scan is determined based on GPS data.

17. The computer system of claim 16, wherein the GPS data is captured from a picker mobile device as an item associated with the item identifier is scanned.

18. The computer system of claim 15, wherein the location data comprises one or more of a map of the store, a location of each item in the order, and a route through the store to each item in the order.

19. The computer system of claim 15, wherein the planogram reflects location ranges of one or more items available at the store.

20. The computer system of claim 15, the actions further comprising:
responsive to receiving new scans for an item identifier at a new location in the store, updating the planogram to include an item associated with the item identifier at the location, wherein the updated planogram includes the item at two or more locations in the store.
